(19) United States
(12) Patent Application Publication
(10) Pub. No.: US 2007/0272270 A1
(43) Pub. Date: Nov. 29, 2007

(54) SINGLE-WAFER CLEANING PROCEDURE

(76) Inventor: Kun-Yuan Liao, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/837,549

(22) Filed: Aug. 13, 2007

Related U.S. Application Data
(63) Continuation-in-part of application No. 10/905,316, filed on Dec. 27, 2004.

(51) Int. Cl. B08B 6/00; C23G 1/00

(52) U.S. Cl. 134/1.3; 134/2

(57) ABSTRACT

A single-wafer cleaning procedure has the steps of providing an etched wafer comprising a photo resist pattern on a front surface of the etched wafer, performing an ashing process to remove the photo resist pattern, hoisting the etched wafer to cool down the etched wafer, and performing a dry cleaning process upon the hoisted etched wafer when the etched wafer is cooled down.

### CROSS REFERENCE TO RELATED APPLICATIONS

This is a continuation-in-part of U.S. patent application Ser. No. 10/905,316 filed Dec. 27, 2004.

### BACKGROUND OF THE INVENTION

1. Field of the Invention

The present invention relates to a single-wafer cleaning procedure, and more particularly, to a single-wafer dry cleaning procedure performed in an ashing reaction chamber to remove polymer particles when the wafer is hoisted up.

2. Description of the Prior Art

The manufacturing of VLSI, ULSI, and MEMS devices are based on a substrate, e.g. a silicon wafer, and are successively implemented by performing hundreds of processes including thin film deposition, oxidization, photolithographic, etching, implantation, etc. As known in the art, polymer particles, which are by-products of the etching reaction, would adhere to the wafer surface, and thus a cleaning process must be performed to remove the polymer products subsequent to the etching process. In such a case, subsequent processes can be continued successfully, and the electrical performance of the MOS element can be ensured.

Please refer to FIG. 1. FIG. 1 is a flow chart exemplarily illustrating a conventional semiconductor manufacturing procedure including a photolithographic process, an etching process, and an ashing process followed by a wet cleaning process. As shown in FIG. 1, the conventional semiconductor manufacturing procedure normally includes the following steps:

Step 10: Perform a photolithographic process to form a photo resist pattern on a thin film positioned on a wafer surface;

Step 12: Perform an etching process using the photo resist pattern as a hard mask to remove unblocked thin film in an etching chamber;

Step 14: Perform an ashing process by introducing oxygen at a high temperature to remove the photo resist pattern in an ashing reaction chamber; and

Step 16: Perform a wet cleaning process by immersing the wafer into at least a cleaning solution tank to remove the polymer particles adhered to the wafer surface (including front surface, back surface, and bevel surface), and rinse the wafer with deionized (DI) water.

The aforementioned wafer cleaning procedure in step 16 is a common way to clean wafers. However, the concentration of the cleaning solution varies with the quantity of wafers processed. Considering wafers of different batches, the cleaning effect of the solution on wafers of any given batch is inevitably poorer compared to the cleaning effect on wafers of a previous batch. Consequently, the quality of subsequent processes is more difficult to control. In the mass production of small-sized wafers, since the critical dimensions are larger and the integration is not high, the conventional cleaning procedure by performing a wet cleaning process is an acceptable solution. However, because critical dimensions are reduced and integration is improved in the fabrication of 12-inch wafers, a single-wafer cleaning procedure is necessary to ensure effective cleaning.

As described above, the process precision involved in the fabrication of large-sized wafers requires strict cleanliness controls, and hence a single-wafer cleaning procedure must be adopted. In addition, if the single-wafer cleaning procedure is implemented by a wet cleaning process in a spinning manner, particles such as polymer particles or organic components would remain on the back surface and the bevel surface of the wafers. These remaining polymer particles become the source of contamination in the reaction chambers of subsequent processes, and therefore affect the quality and yield of these processes.

Recently, dry clean process is also used to clean wafers. U.S. Pat. No. 6,235,640 discloses a method for simultaneously cleaning a photo resist mask employed for etching, and etching a silicon layer at a bottom of contact holes in the same plasma processing chamber. As shown in FIG. 4 of U.S. Pat. No. 6,235,640, Ebel discloses an etching/stripping process including:

Step 402: Start;

Step 404: Perform main contact etch through oxide layer to silicon layer in a plasma processing chamber;

Step 406: Perform combined soft etch/stripping using an etchant source gas that contains fluorocarbon and oxygen in the same plasma processing chamber; and

Step 408: End.

In Ebel's FIG. 5, he specifically explains substeps of the stripping process including:

Step 500: Start;

Step 502: High bombardment stripping substep;

Step 504: Dechuck/stripping substep;

Step 506: Pin-up/stripping substep; and

Step 508: End.

In col. 4, line 45 to col. 5, line 9 of U.S. Pat. No. 6,235,640, Ebel teaches that the substrate is disposed on a carrier e.g. an electrostatic chuck of a plasma etching reaction chamber during etching. And in col. 6, lines 4-19, Ebel teaches that the substrate is raised on pins during stripping to physically separate the substrate from the chuck, and therefore the substrate is allowed to be hotter in the absence of an intimate contact with the chuck.

Ebel's method is characterized in two aspects. First, the etching/stripping step is performed in a plasma etching chamber, and the substrate is placed on a carrier such as electrostatic chuck that is normally equipped with a cooling system to cool down the temperature of the substrate during the etching process. Normally, the process temperature of an etching process is between −20° C. and 60° C. so that the photo resist pattern does not collapse due to high temperature. Second, the stripping step is performed when the substrate is raised on pins in order to make the substrate physically separated from the carrier and become hotter during the stripping step.

### SUMMARY OF THE INVENTION

It is therefore a primary object to provide a single-wafer dry cleaning procedure to remove the polymer particle adhered on the wafer in an ashing reaction chamber when the wafer is hoisted up and cooled down.

In one aspect of the present invention, a single-wafer cleaning procedure is provided. The single-wafer cleaning procedure includes:

providing an etched wafer comprising a photo resist pattern on a front surface of the etched wafer;

performing an ashing process to remove the photo resist pattern; hoisting the etched wafer to cool down the etched wafer; and

performing a dry cleaning process upon the hoisted etched wafer when the etched wafer is cooled down.

In another aspect of the present invention, a single-wafer cleaning procedure is provided. The single-wafer cleaning procedure includes:

providing an etched wafer comprising a photo resist pattern on a front surface of the etched wafer;

loading the etched wafer into an ashing reaction chamber having a hot plate carrier, and placing the etched wafer on the hot plate carrier;

performing an ashing process to remove the photo resist pattern;

hoisting the etched wafer with pins of the hot plate carrier; and

performing a dry cleaning process upon the hoisted etched wafer.

Since the dry cleaning process is performed when the etched wafer is in a hoisted and cooled-down condition in an ashing reaction chamber according to the present invention, polymer particles adhered to the back surface and the bevel surface of the etched wafer can be easily removed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart exemplarily illustrating a conventional semiconductor manufacturing procedure.

FIGS. 2-5 are schematic diagrams illustrating a dry cleaning procedure according to a preferred embodiment of the present invention.

FIG. 6 is a schematic diagram illustrating a dry cleaning procedure according to another embodiment of the present invention.

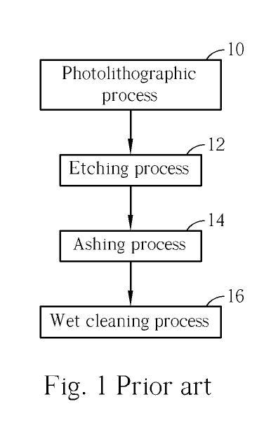

### DETAILED DESCRIPTION

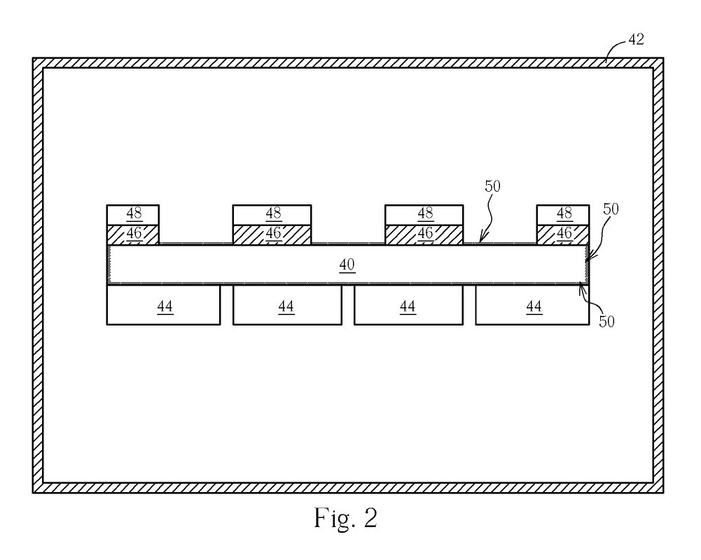

Please refer to FIGS. 2-5. FIGS. 2-5 are schematic diagrams illustrating a dry cleaning procedure according to a preferred embodiment of the present invention. As shown in FIG. 2, a wafer which has just been etched (hereinafter referred to as an etched wafer 40) is loaded into an ashing reaction chamber 42, and placed on a hot plate carrier 44. The hot plate carrier 44 is able to heat the wafer 40 so that the temperature of the wafer 40 can maintain in a proper range. The etched wafer 40 includes a thin film pattern 46, and a photo resist pattern 48 on the front surface for defining the thin film pattern 46. The photo resist pattern 48 is going to be removed in the following ashing process. It is appreciated that the etched wafer 40 frequently includes a plurality of by-products e.g. polymer particles 50 (or organic components) that are unavoidably generated during the etching process. These polymer particles 50 may appear on the front surface, the back surface, and the bevel surface, thereby causing undesired particle issues.

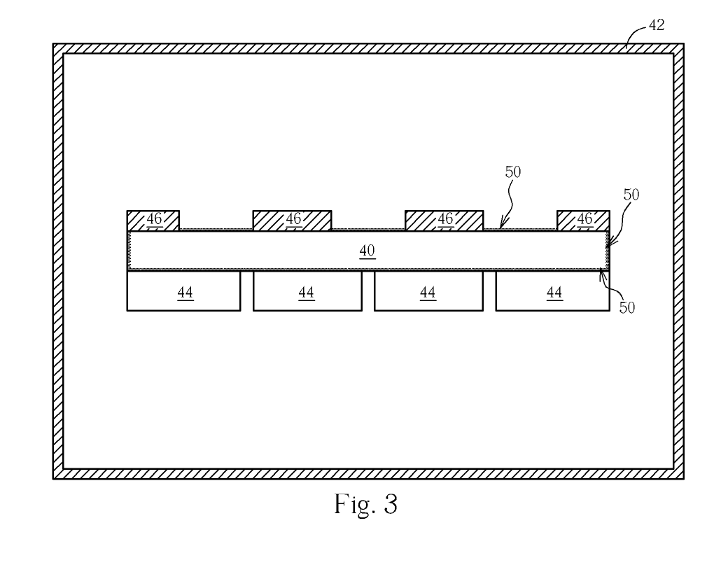

As shown in FIG. 3, an ashing process is performed for example by introducing gases e.g. oxygen, N₂H₂, ozone, or utilizing oxygen-carbon tetrafluoride (O₂—CF₄) plasma, nitrogen oxygen (N₂—O₂) plasma, at a temperature within 150° C. to 300° C. to remove the photo resist pattern 48. In this embodiment, the process temperature is set at approximately 250° C., RF power and RF time are set at 900 W and 20 seconds, the process pressure is set at 1.1 Torr, and the flow rate of O₂ and N₂H₂ are respectively 5000 sccm and 200 sccm. These parameters are not limited by this embodiment. During the ashing process, the photo resist pattern 48 is removed by plasma.

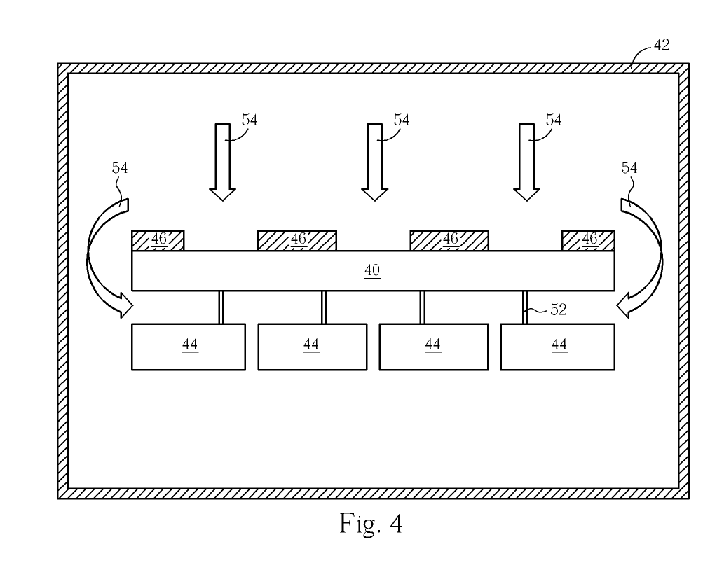

As shown in FIG.4, subsequent to the ashing process, the etched wafer 40 is then hoisted up by pins 52 of the hot plate carrier 44 and undergoes a dry cleaning process in the ashing reaction chamber 42 in an in-situ manner. The dry cleaning process is carried out by, for instance, introducing oxygen and/or N₂H₂ gas into the ashing reaction chamber 42, and RF power is applied to generate plasma 54.

In this embodiment, the process parameters are the same as that of the ashing process. The process temperature is set at approximately 250° C., RF power and RF time are set at 900 W and 20 seconds, the process pressure is set at 1.1 Torr, and the flow rate of O₂ and N₂H₂ are respectively 5000 sccm and 200 sccm. However, the process parameters may be modified wherever necessary. The plasma 54 can remove not only the polymer particles 50 adhered to the front surface, but also the back surface and the bevel surface of the etched wafer 40 since the etched wafer 40 is raised up. The pin-up of the etched wafer 40 in the dry cleaning process also cools down the temperature of the etched wafer 40 in the dry cleaning process compared to the temperature of the etched wafer 40 in the previous ashing process. This is because the pin-up action raises the etched wafer 40 up from the hot plate carrier 44.

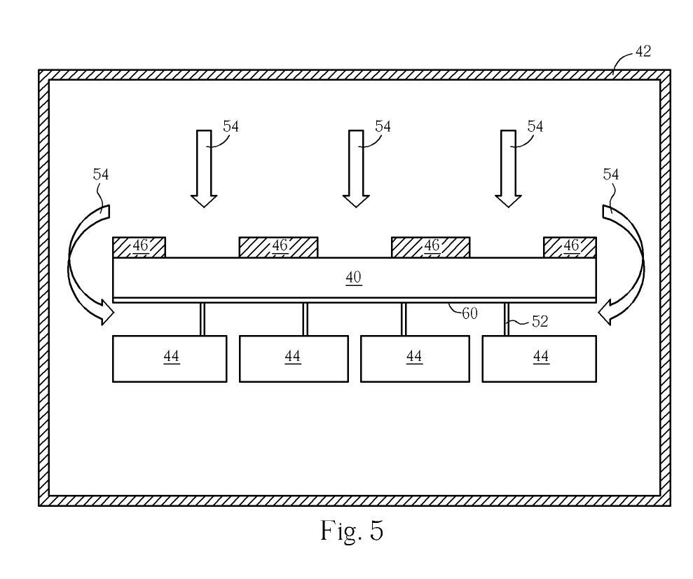

In addition to the aforementioned advantages, the pin-up of the etched wafer 40 can also form a thermal oxide protection layer on the back surface of the etched wafer 40. As shown in FIG. 5, the polymer particles 50 adhered to the front surface, the back surface and the bevel surface have been removed by plasma. Since the etched wafer 40 is hoisted up, the back surface of the etched wafer 40 is not in contact with the hot plate carrier 44 and therefore is exposed. In such a case, oxidation will happen so that a thermal oxide protection layer 60 will be formed on the whole back surface of the etched wafer 40 during the dry cleaning process. The thermal oxide protection layer 60 is more alkali-resistant than silicon material of the etched wafer 40, and thus can protect the back surface of the etched wafer from being damaged by alkaline solution in successive process e.g. wet cleaning process. An intact and smooth back surface ensures an accurate alignment in successive photolithographic process.

The dry cleaning process is not limited to a plasma process, and other suitable cleaning methods can also be adopted to remove the polymer particles 50. For example, the polymer particles 50 on the front surface, back surface, and bevel surface can be burned away by only introducing gases e.g. oxygen, ozone, N₂H₂, etc at a high temperature (e.g. between 150° C. and 300° C.), but not by using plasma. In addition, since the plasma substantially consists of charged ions, radicals, molecules, and electrons, a certain portion of the plasma can be selected to bombard the etched wafer 40 so as to improve the cleaning effect of the dry cleaning process.

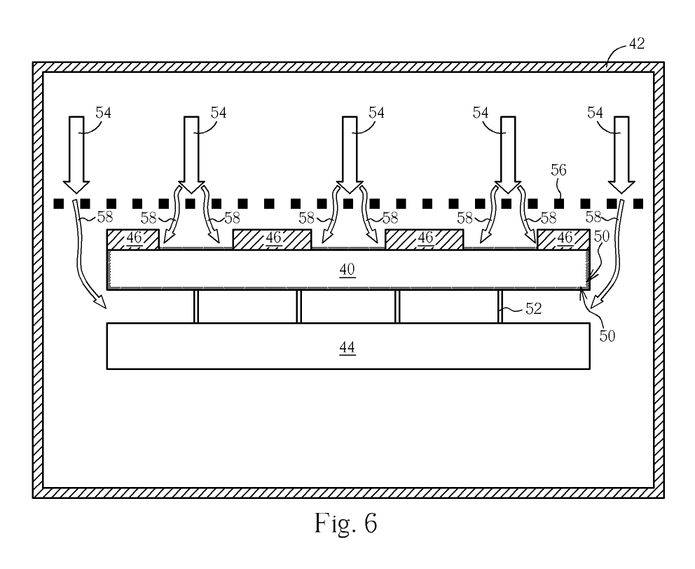

Please refer to FIG. 6. FIG. 6 is a schematic diagram illustrating a dry cleaning procedure according to another embodiment of the present invention. It is appreciated that like numerals represent like components in FIGS. 2-5 and FIG. 6 for better comparison. As shown in FIG. 6, what is different from the previous embodiment is that in this embodiment the radicals 58 of the oxygen plasma 54 are select to bombard the etched wafer 40. Consequently, a filter 56 is installed over the etched wafer 40 for only allowing the radicals 58 of the plasma 54 to pass through. Accordingly, the radicals 58 can remove the polymer particles 50 adhered to the front surface, the back surface, and the bevel surface of the etched wafer 40.

It is to be appreciated that the dry cleaning process aims to remove the polymer particles adhered to the front surface, the back surface, and the bevel surface of the etched wafer when the etched wafer is in a hoisted condition. On the other hand, the ashing process is also a dry process, which works to remove the photo resist pattern positioned on the front surface of the etched wafer. However, the dry cleaning process of the present invention can be implemented in a low pressure reaction chamber, in which the wafer is hoisted, by performing a single plasma process to remove the photo resist pattern and the polymer particles simultaneously. In addition, to ensure the cleanness of the etched wafer, a wet cleaning process can also be performed on the etched wafer after the dry cleaning process. Since the etched wafer may include only a small amount of polymer particles, the concentration of the cleaning solution is not altered dramatically. Furthermore, the pin-up action in the dry cleaning process slightly cools down the temperature of the etched wafer, and a thermal oxide protection layer is formed in the back surface of the etched wafer when the etched wafer is raised.

In conclusion, the prior art utilizes a wet cleaning process to remove the polymer particles adhered to the etched wafer, and thus suffers from variations in the concentration of the cleaning solution. For large-sized wafers, the above-mentioned wet cleaning process is not an acceptable solution in the removal of polymer particles. In comparison with the prior art, the present invention utilizes a dry cleaning process to remove the polymer particles adhered to the front surface, the back surface, and the bevel surface of the etched wafer, and thus has a stable cleaning ability to remove the polymer particles effectively. In addition, it is appreciated that the dry cleaning process of the present invention is performed in an ashing reaction chamber, and the temperature of the etched wafer is cooled down when the etched wafer is raised. However, the temperature of the substrate in Ebel's teaching becomes higher when the substrate is raised.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A single-wafer cleaning procedure, comprising:
providing an etched wafer comprising a photo resist pattern on a front surface of the etched wafer;
performing an ashing process to remove the photo resist pattern;
hoisting the etched wafer to cool down the etched wafer; and
performing a dry cleaning process upon the hoisted etched wafer when the etched wafer is cooled down.

2. The single-wafer cleaning procedure of claim 1, wherein the etched wafer comprises a plurality of polymer particles adhered to the front surface, a back surface, and a bevel surface of the etched wafer.

3. The single-wafer cleaning procedure of claim 2, wherein the dry cleaning process is performed to remove the polymer particles adhered to the front surface, the back surface, and the bevel surface of the etched wafer.

4. The single-wafer cleaning procedure of claim 1, wherein the dry cleaning process comprises an oxygen plasma process using an oxygen plasma.

5. The single-wafer cleaning procedure of claim 4, wherein an oxide layer is formed on a back surface of the etched wafer during the oxygen plasma process when the etched wafer is hoisted up.

6. The single-wafer cleaning procedure of claim 4, wherein the oxygen plasma comprises charged ions, radicals, molecules, and electrons.

7. The procedure of claim 6, wherein during the dry cleaning process, a filter is installed over the etched wafer for only allowing the radicals to pass through.

8. The single-wafer cleaning procedure of claim 1, wherein the ashing process and the dry cleaning process are performed in an in-situ manner in a same reaction chamber.

9. The single-wafer cleaning procedure of claim 8, further comprising performing a wet cleaning process after the dry cleaning process is performed.

10. The single-wafer cleaning procedure of claim 1, wherein the etched wafer is hoisted up with pins of a hot plate carrier.

11. A single-wafer cleaning procedure, comprising:
providing an etched wafer comprising a photo resist pattern on a front surface of the etched wafer;
loading the etched wafer into an ashing reaction chamber having a hot plate carrier, and placing the etched wafer on the hot plate carrier;
performing an ashing process to remove the photo resist pattern;
hoisting the etched wafer with pins of the hot plate carrier; and
performing a dry cleaning process upon the hoisted etched wafer.

12. The single-wafer cleaning procedure of claim 11, wherein the etched wafer comprises a plurality of polymer particles adhered to the front surface, a back surface, and a bevel surface of the etched wafer.

13. The single-wafer cleaning procedure of claim 12, wherein the dry cleaning process is performed to remove the polymer particles adhered to the front surface, the back surface, and the bevel surface of the etched wafer.

14. The single-wafer cleaning procedure of claim 11, wherein the dry cleaning process comprises an oxygen plasma process using an oxygen plasma.

15. The single-wafer cleaning procedure of claim 14, wherein an oxide layer is formed on a back surface of the etched wafer during the oxygen plasma process when the etched wafer is hoisted up.

16. The single-wafer cleaning procedure of claim 14, wherein the oxygen plasma comprises charged ions, radicals, molecules, and electrons.

17. The procedure of claim 16, wherein during the dry cleaning process, a filter is installed over the etched wafer for only allowing the radicals to pass through.

18. The single-wafer cleaning procedure of claim 11, wherein the ashing process and the dry cleaning process are performed in an in-situ manner in a same reaction chamber.

19. The single-wafer cleaning procedure of claim 18, further comprising performing a wet cleaning process after the dry cleaning process is performed.

20. The single-wafer cleaning procedure of claim 11, wherein when the etched wafer is hoisted with the pins of the hot plate carrier, the etched wafer is cooled down.
